(19) United States
(12) Patent Application Publication
(10) Pub. No.: US 2022/0222753 A1
(43) Pub. Date: Jul. 14, 2022

(54) SYSTEM AND METHOD FOR PROVIDING AND INSURING A PUBLIC SERVICE

(71) Applicant: Mike Evans Caradimitropoulo, Roseland, NJ (US)

(72) Inventor: Mike Evans Caradimitropoulo, Roseland, NJ (US)

(21) Appl. No.: 17/706,798

(22) Filed: Mar. 29, 2022

Related U.S. Application Data
(63) Continuation of application No. 16/657,230, filed on Oct. 18, 2019, now abandoned.
(60) Provisional application No. 62/747,259, filed on Oct. 18, 2018.

(51) Int. Cl. G06Q 40/08; G06Q 50/26

(52) U.S. Cl. CPC G06Q 40/08; G06Q 50/26

(57) ABSTRACT

A system for providing and insuring a public service that includes a plurality of computing devices, each in communication with a user is disclosed. The computing devices include a processor configured to perform a set of instructions stored in a database, which is in operable communication with an application. An insurance provider is in operable communication with the application. The insurance provider provides insurance coverage for one or more predetermined parameters related to a predefined service. A financial institution is in operable communication with the user and is configured to send and receive a payment for the predefined service.

### CROSS-REFERENCE TO RELATED APPLICATIONS

The present application claims priority to U.S. Provisional Application No. 62/747,259 filed on Oct. 18, 2018, entitled “SYSTEM AND METHOD FOR PROVIDING AND INSURING A PUBLIC SERVICE” and is a Continuation of U.S. Non-Provisional application Ser. No. 16/657,230 filed on Oct. 18, 2019 entitled “SYSTEM AND METHOD FOR PROVIDING AND INSURING A PUBLIC SERVICE” and the entire disclosure of which is incorporated by reference herein.

### FIELD

The embodiments relate to a system and method for providing dynamic insurance to a public service provider, and, more specifically, relates to sourcing and providing insured snow removal services.

### BACKGROUND

Large populations are exposed to seasonal snow conditions. This requires the affected populations to remove the snow obstructing doorways, driveways, parking lots, or other areas where high levels of snow impact daily life. Snow removal can be done by the property owner or by a snow removal service, which charges a fee.

Currently, snow removal services are scheduled depending on weather conditions. Each operator has a predetermined route without the ability to amend the route for individuals requesting expedited plowing. No system exists for property owners or operators alike to request or solicit snow removal services in a single platform. Further, no system exists which includes accurate scheduling and database logs of services rendered to provide a reliable method for assessing insurance claims.

Snow removal services and operators thereof are subjected to large amounts of liability inherent in their daily operations. Service providers are required to maintain an insurance policy, but in most cases by attaching a plow or device to their vehicle their personal insurance policy voids an insurance claim while the plow device is in use. No insurance is provided by the service provider for completed operations on a daily basis who has a personal or commercial auto policy for slip and fall or property damage. However, if the provider buys an insurance policy for an entire season the plans are often far too expensive for small companies and individuals, exposing them to liabilities.

### SUMMARY OF THE INVENTION

Embodiments are provided a system for providing and insuring a public service. The system includes a plurality of computing devices each in communication with a user. The computing devices include a processor configured to perform a set of instructions stored in a database, which is in operable communication with an application. An insurance provider is in operable communication with the application. The insurance provider provides insurance coverage for one or more predetermined parameters related to a predefined service. A financial institution is in operable communication with the user and configured to send and receive a payment for the predefined service.

The embodiments provide insurance to a service provider at the time of use and for 24 hours, or similar predetermined time period after the service is completed. The systems keep track of the time the vehicle is in use and the service is performed. The service provider is able to buy the insurance policy and cancel within 24 hours of completing the service for a fee. This low-cost option for service provider insurance is not available in the current industry.

In one aspect, the predetermined parameters include the location of the user, a fee for the predefined service, and/or a schedule for the predefined service. The predefined service includes the removal of snow, salting a surface, and/or sanding a surface.

In one aspect, the insurance provider provides an insurance policy to the user for a predetermined period of time, such as for a single day. The financial institution may release the payment if the user determines the service is satisfactory.

A method for providing and insuring a public service includes downloading, via a user, an application to a computing device. The application includes instructions performed by a processor. The computing device is in communication with an insurance provider and a financial institution via a network. A service is requested while the user provides one or more parameters for the request. Once the request is accepted, the service is performed, and a satisfaction level is determined based on the performance of the service.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a block diagram of the system architecture, according to some embodiments;

FIG. 2 illustrates a block diagram of the network infrastructure, according to some embodiments;

FIG. 3 illustrates a flowchart of the user flow for a service provider, according to some embodiments;

FIG. 4 illustrates a flowchart of the user flow for a requester, according to some embodiments;

FIG. 5 illustrates a flowchart of the method of use, according to some embodiments;

FIG. 6 illustrates a block diagram of the server engine and modules, according to some embodiments;

FIG. 7 illustrates a block diagram of the server engine and modules, according to some embodiments; and

FIG. 8 illustrates a block diagram of the server engine and modules, according to some embodiments.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

in general, the embodiments described herein relate to a mobile application platform providing the ability for snow removal personnel to provide their service, as well as for individuals to request the services of a snow removal operator. The term “user” may refer to a requester or a service provider. The term “requester” comprises users who are soliciting the services of the snow removal operators. The requester user can include property owners and managers, either residential or commercial. One skilled in the arts will recognize that while the provided embodiments relate to the services of snow removal, various services can utilize the embodiments as a means for providing, soliciting, and insuring the service. The term “service provider” comprises snowplow companies, snowplow vehicle operators, snow shovel operators or other individuals operating to remove snow from an area. The service providers may also be employees or independent contractors for entities performing the service of snow removal.

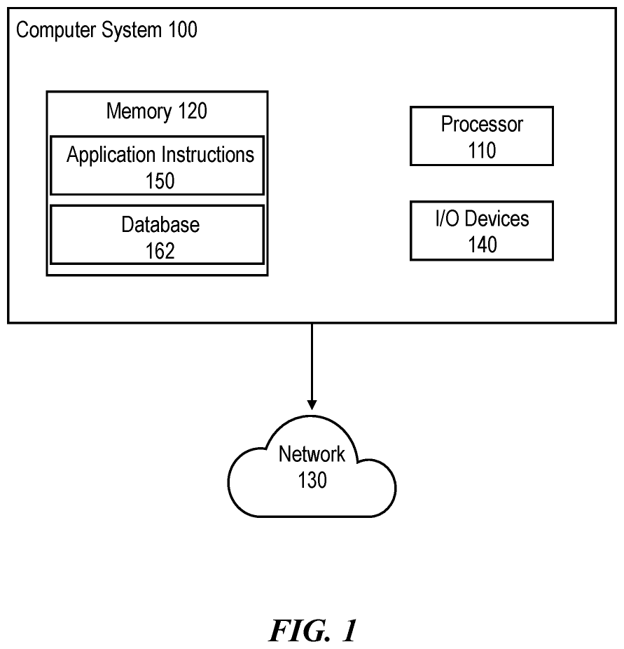

FIG. 1 illustrates a computer system 100, which may be utilized to execute the processes described herein. The computing system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 162, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

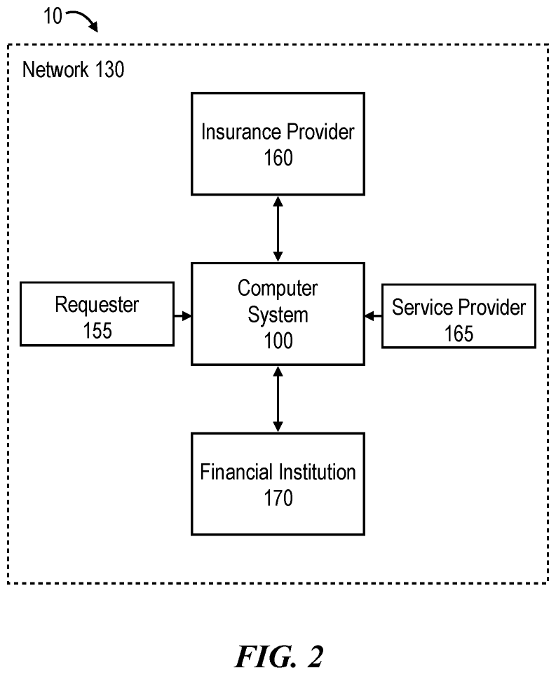

FIG. 2 illustrates a block diagram a an example system 10 having an application for providing and requesting the service of snow removal, according to some embodiments. The system 10 can include requesters and service providers, each utilizing respective computing device 140 in communication with a server via network 130. The processor of the computing device will receive instmetions (e.g., from a memory) and execute those instructions, thereby performing one or more processes defined by those instructions. Instructions are embodied in the application which provides an on-demand snow maintenance service to requesters. Further, the application serves as a platform to provide insurance by an insurance provider 160, and as a payment platform via a financial institution 170 in communication with the network 130.

In some embodiments, the computing devices store or have access to data items, via the database, related to insurance information via the insurance provider 160, user preferences. Each computing device may include a processor 110 capable of performing the instructions related to the application. One or more input/output (I/O) devices 140 are in communication with the processor 110 to input data from the requester 155 or the service provider 165.

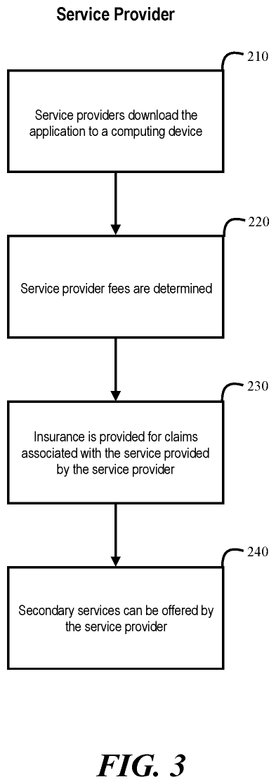

FIG. 3 illustrates a flowchart for the service provider in an exemplary embodiment. The service. provider first downloads the application to their computing device in step 210 to access the community of users, which includes other service providers in addition to the requesters (requesters of the service). In step 220, the service provider can determine the fees for the service to he provided. Fees may change depending on the scope of services, the location where the services are performed, the schedule of the service provider, or the scarcity of the service or particular service provider. One skilled in the arts will recognize that a variety of parameters may be utilized to determine a fee for services rendered. In step 230, if an insurance claim is submitted, the application provides insurance information via the insurance provider. In step 240, secondary services may be selected related to the service, to be performed by the service provider. In the example of snow removal, the primary service can include removing snow from a defined area while a secondary service may include salting or sanding a defined area.

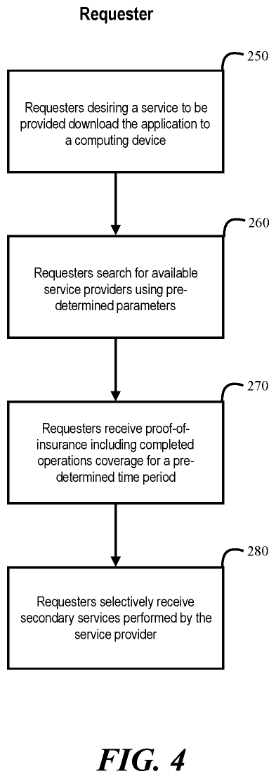

In reference to FIG. 4, the requester can download the application to a computing device in step 250 and request for a service at a requester-determined time and location. In step 260, the requester can search for available service providers using parameters including location, schedule availability, the scope of services offered, fee amount or structure, or other parameters known in the arts. In step 270, the requester receives proof-of-insurance provided by the insurance provider to the service provider. In step 280, the requester may select from a list of secondary services to be performed by the service provider.

In some embodiments, the insurance provider provides insurance coverage to the service provider for a predetermined time period for the services rendered to the requester. In one example, the insurance provider 160 provides daily insurance to a service provider 165 for a predetermined service route. One skilled in the arts will appreciate that a variety of insurance plans may be utilized, such as providing additional insurance to he purchased upon the rendering of additional services throughout the service route.

In some embodiments, the insurance provider 160 provides insurance coverage to the requester 155 for a predetermined time period for the service parameters selected.

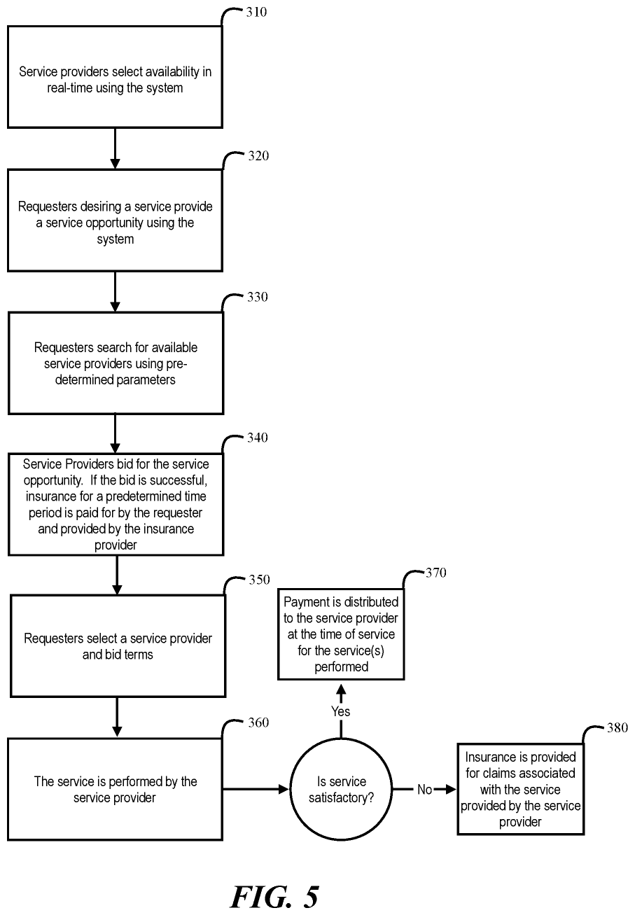

FIG. 5 illustrates a flowchart of an exemplary user-flow. In step 310, the service provider selects availability in real-time such that a requester desiring a service provides a service opportunity by requesting a service in step 320. Service providers can then hid to engage in the services specified by the requester. The requester then searches for a service provider and insurance for the specified service parameters is provided by the insurance provider in step 330. In step 340 and 350, requesters can select a service provider from a list of service providers who have submitted a bid for the service request. Proper insurance will be confirmed and displayed to the requester such that the requester knows he or she is selected as a properly-insured service provider. In step 360, the service is performed by the service provider. In step 370, if the requester is satisfied with the services rendered, payment is distributed to the service provider by the financial institution. The requester may accept or deny the satisfaction of the services provided such that if the requester is unsatisfied, the payment distribution may be withheld, or profits forfeited in step 380, and an insurance claim can be submitted.

In some embodiments, if the requester determines the services rendered by the service provider are satisfactory, the requester may option to engage in a secondary insurance plan. The secondary insurance plan can he valid for a predetermined time period, such as ten days.

In some embodiments, the I/O device 140 can include geolocation devices such as a GPS to aid in the determination of the location of the requester and service provider.

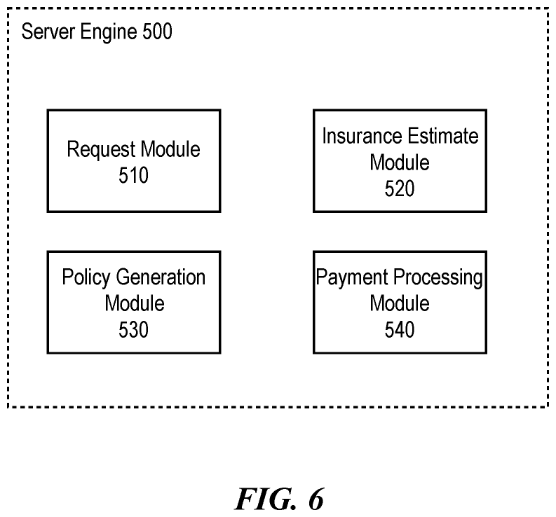

In reference to FIG. 6, the server engine 500 and modules are illustrated according to an exemplary embodiment. FIG. 6 illustrates modules which may be utilized by the insurance provider to perform the various tasks described herein. A request module 510 may generate and receive an insurance request from a requester related to a service performed by the service provider. The request may be autonomously processed by the request module 510 to determine the terms of the request generated and transmitted by the requester. An insurance estimate module 520 determines the terms of the insurance policy which will be generated by the policy generation module 530. The insurance estimation module may determine the scope of work to he performed by the service provider. Payment is transmitted by the user via the payment processing module 540 to the financial institution for the service rendered and the insurance policy for the services rendered.

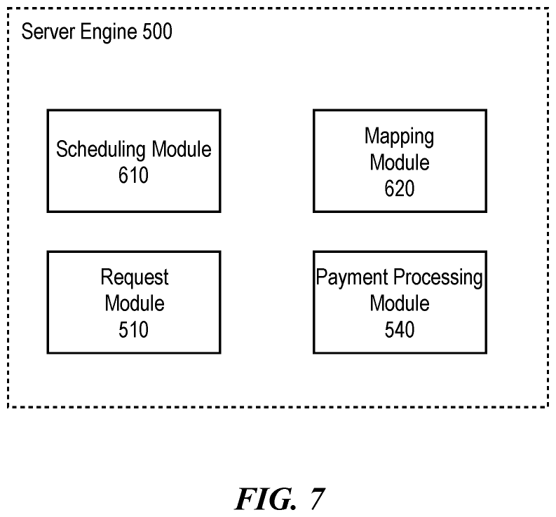

FIG. 7 illustrates the server engine 500 and modules associated with performing tasks by the requester in exemplary embodiments. A scheduling module 610 receives and provides a. schedule to determine available times for the service provider to perform a service, such as snow plowing, at a requester-specified location. The scheduling module 610 may receive a request from the request module 510 for a service at a requester-determined time and location and generate an accept or deny response to the requester. If the request is accepted, the requester will receive a confirmation and the scheduling module will schedule the service to be performed for a period of time, which is available on the schedule of the service provider. The mapping module 620 determines the locations of a plurality of services to he performed by, the service provider and determines a time during which the service provider must travel between each location. The mapping module 620 is in communication with the scheduling module to determine an accurate time for performing each task and traveling therebetween. The request module 510 permits the requester to generate and transmit a request for the services which the requester needs. or example, the request may request for snow plowing, snow removal, salting, sanding a surface, or other snow removal and snow maintenance services. The payment processing module 540 receives payment information from the user and transmits the payment information to the financial institution.

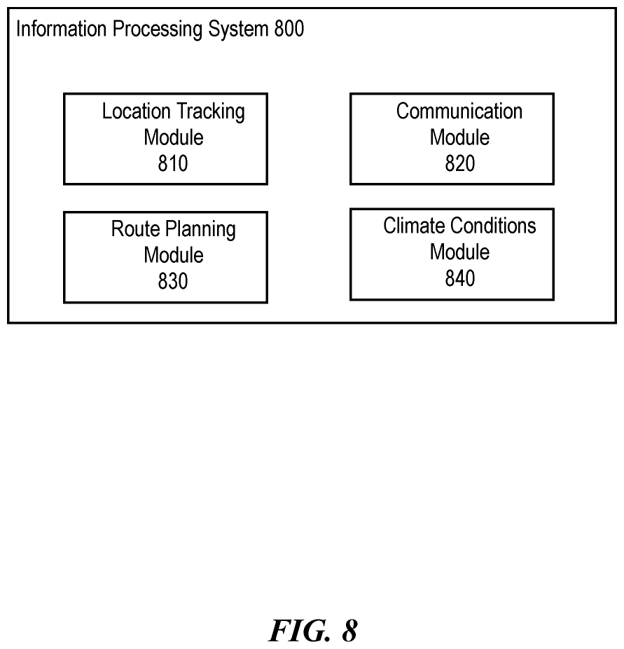

FIG. 8 illustrates a block diagram of a service provider system utilized by the service provider to perform tasks requested by the requester and insured by the insurance provider. The service provider system is comprised of a location tracking module 810 which collects and maintains a route schedule. route schedule history, and map data of the service provider travel routes and historical data for services provided by the service provider. For example, data may include streets and routes traveled by the service provider. The location tracking module may include any means of tracking the service provider's location, including a global positioning system (GPS), checkpoints, driver input, and the like. A communication module 820 transmits service provider communications to and from the system, including location data received from the location tracking module 810. The communication module 820 may transmit real-time location data to the system to be displayed to the requester to provide accurate and real-time location of the service provider. The communication module may also allow various users of the system to communicate with one another. A route planning module 830 receives requests from a plurality of requesters as well as route planning data to determine an optimal route for the service provider. The route planning data includes snow depth data from a weather service to determine locations where snow removal is needed. One skilled in the art will readily understand other services which may utilize a route planning module and route planning data. In some embodiments, the information processing module may further comprise a climate conditions module 840 to analyze climate conditions for a plurality of geographical regions. The climate conditions module may be in operable communication with the system to determine a demand for the services provided by the service provider in a region at a particular time period.

In some embodiments, the data collected by the system can vary depending on the application. For example, information from vehicle sensors can include such things as vehicle information, vehicle speed, vehicle acceleration, engine revolutions-per-minute, engine temperature, engine oil pressure, and fuel level. Information collected from third party sources may include weather data, such as from the National Weather Service, forecasts, and local and regional radars and related information such as front location, snow depth, wind conditions, as well as current traffic conditions.

In some embodiments, information collected from weather stations and weather pods can include current surface and ambient temperatures, humidity, wind speed and direction, wind chill, rain, snow, and fog, and in general any weather condition, trend, forecast or information. Other types of information that can be gathered or otherwise calculated from gathered data include road conditions, physical location, snowplow setting, mixture and amount of material being applied to a selected surface, video images of the vehicle's exterior environment.

The webpage or interface on the display can also provide a spatial map showing vehicle locations, vehicle operations, and other state information. For example, the map can depict the location of the snowplow as well as the other snowplow trucks relative to the initial truck, using an icon denoting each truck. The icon color can be varied to indicate differing vehicle states. Text and/or visual (camera) information can be depicted on the map adjacent to or associated with each icon. The text information can describe selected state information associated with the truck, such as a truck identifier, direction of travel, speed, status of GPS signal, status and activity, and timestamp of last data update for the identified truck. The map can also depict, for one or more selected vehicles, a trace route over a selected period of time and/or a trace route indicating the path of travel of the vehicle over the selected time period. The map can also display reported conditions and status of the vehicle, activities (such as treatment material, quantities of material used, blading: speeds, time, images, etc.). Such historical information can then be factored into new forecasts, treatment strategies and recommendations, as well as being directly accessible by maintenance and other personnel and by the traveling public. Additionally, the display can show the recommendation for the specific vehicle, which the driver may accept or make modifications. Such modifications, as well as the actual applications as put forth throughout a route, would then be transmitted back to the information management system and saved as part of the history of actions taken in the relevant region and used as a basis for subsequent strategies and recommendations.

In some embodiments, the system provides insurance to a service provider at the time of use and for 24 hours, or similar predetermined time period after the service is completed. The systems keep track of the time the vehicle is in use and the service is performed. The service provider is able to buy the insurance policy and cancel within 24 hours of completing the service for a fee.

In some embodiments, the requester utilizes the user interface to determine the location of the service provider. For example, the requester utilizes a map application to provide an indicator corresponding to the location of the service provider.

In some embodiments, the system provides an income reporting means, such as a system which stores income made by the service provider.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of ail combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for providing and insuring a public service comprising:
a plurality of computing devices including a processor configured to perform a set of instructions stored in a database in operable communication with an application configured to provide a service to a requester;
an insurance provider in operable communication with the application, the insurance provider providing insurance coverage for one or more predetermined parameters related to a predefined service requested by the requester; and
a financial institution in operable communication with the requester and configured to send a payment to the insurance provider and the service provider and permit the insurance provider and the service provider to receive a payment for the predefined service.

2. The system of claim 1, wherein the predetermined parameters include at least one of the following:
a location of the requester;
a fee for the predefined service; and
a schedule for the predefined service.

3. The system of claim 1, wherein the predefined service includes at least one of the following: the removal of snow, salting a surface, and sanding a surface.

4. The system of claim 1, wherein the insurance provider provides an insurance claim to the user for a predetermined period of time.

5. The system of claim 4, wherein the financial institution releases the payment if the requester determines the service is satisfactory via a payment processing module.

6. A system for providing and insuring a public service comprising:
a plurality of computing devices including a processor configured to perform a set of instructions stored in a database in operable communication with an application configured to provide a service to a requester via a plurality of service providers;
an insurance provider in operable communication with the application, the insurance provider providing an insurance estimate via an insurance estimate module for one or more predetermined parameters related to a predefined service requested by the requester; and
a financial institution in operable communication with the requester and configured to send a payment to the insurance provider and the service provider and permit the insurance provider and the service provider to receive a payment for the predefined service.

7. The system of claim 6, further comprising a location tracking module to determine the location of the service provider.

8. The system of claim 7, further comprising a route planning module to plan a route planning module to determine an optimal route for the service provider.

9. The system of claim 8, further comprising a communication module to permit communication between the requester, the insurance provider, and the service provider.

10. The system of claim 6, further comprising a policy generation module in operable communication with the insurance estimate module to generate an insurance policy for the predefined service.

11. The system of claim 6, wherein the predetermined parameters include at least one of the following:
a location of the requester;
a fee for the predefined service; and
a schedule for the predefined service.

12. The system of claim 6, wherein the predefined service includes at least one of the following: the removal of snow, salting a surface, and sanding a surface.

13. The system of claim 6, wherein the insurance provider provides an insurance claim to the user for a predetermined period of time.

14. The system of claim 10, wherein the financial institution releases the payment if the requester determines the service is satisfactory.

15. The system of claim 11, further comprising a mapping module to track locations of the plurality of service providers.

16. The system of claim 12, wherein the mapping module is in operable communication with a scheduling module

17. A method for providing and insuring a public service comprising:
downloading, via a user, an application to a computing device, the application including instructions performed by a processor, the computing device in communication with an insurance provider and a financial institution via a network;
requesting a service to be provided, and providing one or more parameters for the request;
performing the service; and
determining a satisfaction level based on the performance of the service.

18. The method of claim 17, wherein the one or more parameters include at least one of the following:
a location of the requester;
a fee for the predefined service; and
a schedule for the predefined service.

19. The system of method 18, wherein the service includes at least one of the following: the removal of snow, salting a surface, and sanding a surface.

20. The system of method 19, the insurance provider providing an insurance claim to the requester for a predetermined period of time.
